(19) United States
(12) Patent Application Publication
(10) Pub. No.: US 2008/0140565 A1
(43) Pub. Date: Jun. 12, 2008

(54) INTELLIGENT POWER PORT

(76) Inventors: Vittorio G. DeBenedetti, Warren, MI (US); Carl Jacobs, Huntington Woods, MI (US)

Correspondence Address: MILLER, CANFIELD, PADDOCK AND STONE;MARJORY G. BASILE, ESQ., 150 W. JEFFERSON, SUITE 2500, DETROIT, MI, 48226, US

(21) Appl. No.: 11/952,403

(22) Filed: Dec. 7, 2007

Related U.S. Application Data
(60) Provisional application No. 60/868,984, filed on Dec. 7, 2006.

(51) Int. Cl. H02J 13/00; G06Q 20/00

(52) U.S. Cl. 705/39; 307/35; 307/39

(57) ABSTRACT

An intelligent power port device comprising an outlet providing power and a controller located adjacent the outlet which monitors current and voltage at the outlet, and which is programmable to control power supplied by the outlet. The controller is in electrical communication with controllers of other intelligent power port devices, forming an intelligent power port network.

### RELATED APPLICATION

This application claims priority benefit of U.S. provisional patent application No. 60/868,984 filed on Dec. 7, 2006.

### FIELD OF THE INVENTION

This invention relates to improvements in power ports, and more particularly to improvements for power ports connected together.

### BACKGROUND OF THE INVENTION

Increasingly, people traveling are using portable electronic devices, including for example, laptop computers, Blackberry devices, mobile phones, iPhones, etc. Each of these devices requires a power source, and many of these devices also are more useful with an internet connection. U.S. Pat. No. 5,812,643 to Schelberg Jr. et al discloses a power and telecommunications access vending machine which has a switchable power circuit and a telecommunications access circuit. A user who wants power for his portable electronic device pays a fee, is connected to the vending machine, and is granted access to power and telecommunications services for a limited period of time. Such a device is desirable in that it allows users to charge up their portable electronic devices, and access data transmission lines in places where travelers congregate for extended periods of time, such as at airport terminals, railway stations and similar facilities. However, competing power demands from numerous different sources may overload the system and trip circuit breakers.

A hospital is another example of a location that can have a series of power ports which can be electrically connected to one another to supply electricity for all of the devices which use power. Multiple devices on the same circuit could overload the circuit, tripping the circuit breakers. This is not acceptable for many electrically powered devices that have to be able to work at any time. As a result, multiple circuit breakers have to be used.

U.S. Pat. No. 7,276,915 to Euler et al discloses an electrical service monitoring system which allows a consumer to monitor electric power usage in his residence. A single power monitor at a breaker box monitors current at a series of outlets in a house. However, such a system is limited in that since there is no controlling agent at each outlet, power can only be controlled uniformly across the network and not tailored uniquely for each outlet. It would be desirable to provide a reasonable costing controller which can monitor the current demand at all of a series of power ports so as to help prevent tripping breakers.

### SUMMARY OF THE INVENTION

In accordance with a first aspect, an intelligent power port device is provided comprising an outlet providing power and a controller located adjacent the outlet which monitors current and voltage at the outlet, and which is programmable to control power supplied by the outlet. The controller is in electrical communication with controllers of other intelligent power port devices, forming an intelligent power port network.

From the foregoing disclosure and the following more detailed description of various preferred embodiments it will be apparent to those skilled in the art that the present invention provides a significant advance in the technology of power distribution. Particularly significant in this regard is the potential the invention affords for providing a high quality, low cost intelligent power port device which can control and protect multiple ports efficiently. Additional features and advantages of various preferred embodiments will be better understood in view of the detailed description provided below.

### BRIEF DESCRIPTION OF THE DRAWINGS

FIG. 1 is a schematic representation of a preferred embodiment of a device for monitoring and controlling various ports, including power ports and data ports.

FIG. 2 is a perspective view of a preferred embodiment of one of the intelligent power port devices shown in FIG. 1 with power ports and optional data ports.

FIG. 3 is a schematic block diagram of the intelligent power port device of FIG. 2.

FIG. 4 is a flow chart showing the logic steps for monitoring current levels at each power port and checking to make sure such levels do not exceed a predetermined current limit.

It should be understood that the appended drawings are not necessarily to scale, presenting a somewhat simplified representation of various preferred features illustrative of the basic principles of the invention. The specific design features of the intelligent power port device as disclosed here, including, for example, the specific dimensions of the display, will be determined in part by the particular intended application and use environment. Certain features of the illustrated embodiments have been enlarged or distorted relative to others to improve visualization and clear understanding. In particular, thin features may be thickened, for example, for clarity of illustration. All references to direction and position, unless otherwise indicated, refer to the orientation illustrated in the drawings.

### DETAILED DESCRIPTION OF CERTAIN PREFERRED EMBODIMENTS

It will be apparent to those skilled in the art, that is, to those who have knowledge or experience in this area of technology that many uses and design variations are possible for the intelligent power port disclosed here. The following detailed discussion of various alternative and preferred features and embodiments will illustrate the general principles of the invention with reference to an intelligent pay for use power port suitable for use in airports, and the like. Other embodiments suitable for other applications such as hospitals and libraries will be apparent to those skilled in the art given the benefit of this disclosure.

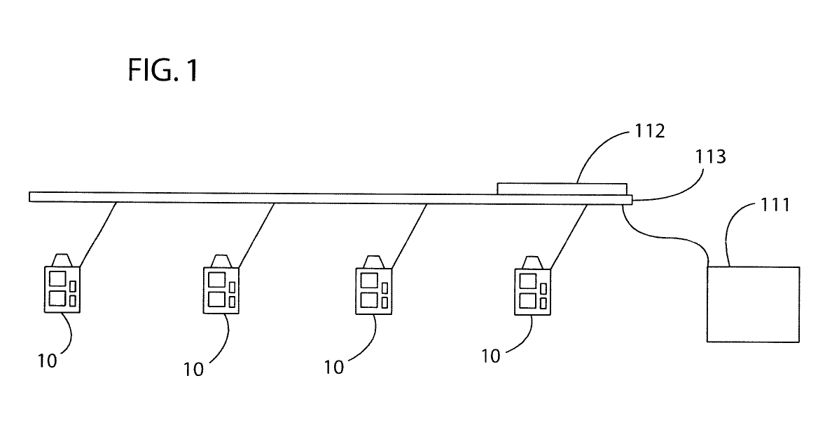

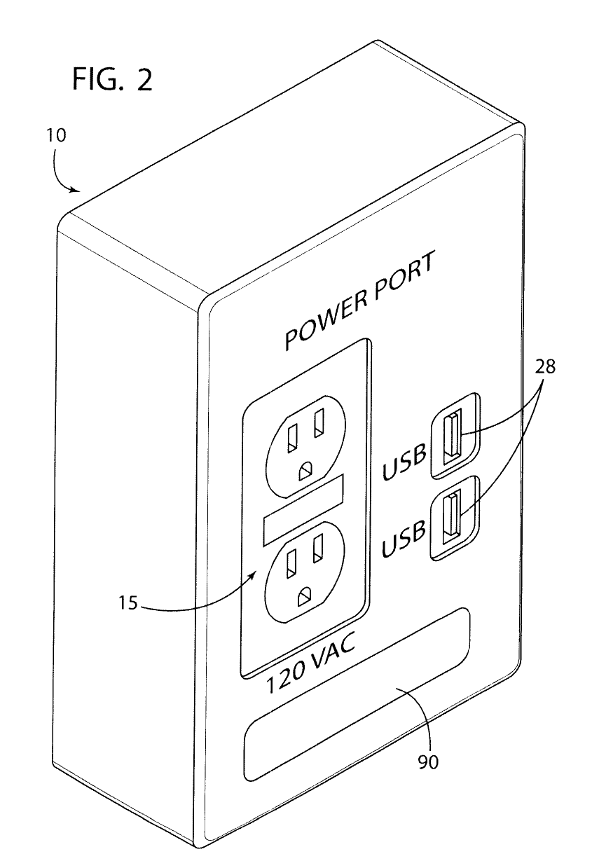

Referring now to the drawings, FIG. 1 shows a series of intelligent power port devices 10 in electrical communication with one another over a main power line 113 and main power source 111 in accordance with a preferred embodiment, forming an intelligent power port network. A master controller 112 may be provided. The overall network can comprise, for example, a series of pay for use power ports provided at an airport terminal. FIG. 2 shows a representative intelligent power port device 10. The power port device 10 has a power outlet, preferably an AC receptacle 15 (although DC power may also be provided at the outlet) and a display 90, which can display information in a variety of formats. In accordance with a highly advantageous feature, a controller is located adjacent the outlet. That is, the controller is part of the device and not located remote from the device. The controller performs a number of highly advantageous operations: it monitors current usage and voltage, for example as a “Wattage monitor” at a ground fault indicator “GFI” AC receptacle/outlet 15. The controller is programmable to control power supplied by the outlet. Also, the controller is preferably in electrical communication with controllers of other intelligent power port devices, forming the intelligent power port network.

The controller may be programmed in a variety of ways. For example, if the AC current supplied at an outlet surpasses a predetermined current limit level the controller can interrupt current to the outlet for a preprogrammed time. The controller can then check to see if the current level has been reduced or removed. If the load has been removed then the current can be reintroduced to the AC receptacle.

Similarly, the controller may be programmed to enable, disable and monitor any other intelligent ports that may be present in the system, including, for example, universal serial bus ports 28, “Fire-Wire” ports, power over Ethernet, and other data ports. Advantageously, the controller for each intelligent power port device may be operatively connected to controllers for other intelligent power port devices within the network. Thus, a large power grid system of power ports optionally can be accessed and controlled by a main controller. The current of multiple devices may be summed to calculate total amount of current being used on a main 120V AC circuit breaker. The controller can than send the remaining current as a parameter to all power ports which then can change their current limit based upon this remaining current. This monitoring algorithm allows for placement of as many power ports on one power circuit branch as needed without the worry of tripping circuit breakers and/or exceeding wire gauge limitations. The controller can also be design to be included inside a circuit breaker.

The power port devices disclosed herein has many ways of communicating between each other and with a master controller, when present. Several suitable technologies may be used, including, for example “RS232 RS485”, “I2C Bus Technology-Hard Wired System”, “Bluetooth Wireless”, “Wifi-Wireless Ethernet”, “ZigBEE Wireless”, “X10 systems” or Broad Band over Power BOP, etc. Depending on customer specifications any one of these technologies can be used with a simple add on card internal to the intelligent power port device circuitry. The power port device with controller disclosed herein advantageously may fit in a standard electrical single gang box. The front plate of the power port device is preferably designed to extend the depth of the box to make room for circuit board mounted on back of the GFI AC plug.

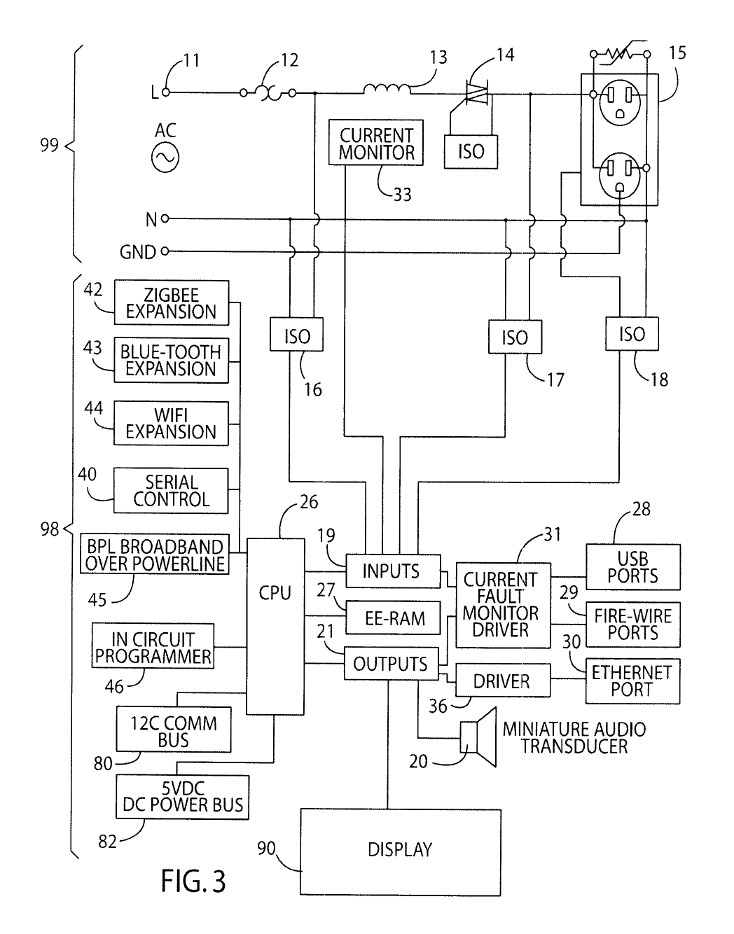

FIG. 3 shows a schematic circuit diagram of a circuit in accordance with a preferred embodiment with AC input 11 of 120 VAC for American standards or 240 VAC for European Standards as a power supply. High voltage AC side 99 is separated from low voltage DC side 98 by one or more optocouplers ISO, or other suitable components. A 20 Amp thermal resetable fuse 12 is provided. If current draw is more than a predetermined amount of a rated current, such as 20 Amps or 135% of a rated current, then the fuse will reach a high resistance value at which current will stop flowing. Only after a cool down period of, for example, approximately 30 seconds will the fuse resistance lower to a point at which current will flow again. This fuse is used to protect the circuit and its components from being damaged.

All circuit board conductive pathways or traces are preferably designed to operate at least 200% higher than the fuse limiting current rating over time. An AC to DC 16 optocoupler is used after the thermal fuse 12 to monitor its status. If the fuse is not tripped a current will run through the optocoupler which is then converted to a DC voltage connected to an input port of the central processing unit CPU or PIC microcontroller 26.

The CPU 26 monitors the status of fuse 12 so that if the fuse trips due to overload the CPU 26 can then run a programmed routine to command a piezo speaker 18 to produce a chirp like sound. The sound indicates that an overload condition has occurred. The CPU 26 can also store status of the fuse so that a master controller can poll this register and display a message or run a pre-programmed routine.

A measurement transducer such as a Hall Effect sensor 13 can be used to measure the amount of current being drawn from the GFI AC receptacle/outlet 15. The transducer 13 uses a field effect to translate eddy current fields that are created by a wind of twenty four turns of magnetic 12AWG wire insulated with polyurethane and nylon into a isolated low voltage analog signal. That is, the output voltage of the sensor varies in response to changes in magnetic field density. This signal is conditioned and scaled to return a proportional current to voltage conversion so that CPU 26 can monitor current and voltage output at the outlet 15. The voltage is converted to digital by means of internal A-D converter built into the CPU 26. The digital number is scaled to represent the AC Current in a number form. This number can be used in a program routine to react to a given value. For example, if a given value or limit is reached, then the program routine can disable the GFI AC receptacle 5 by disabling the output of Triac control Optocoupler 14. This is highly advantageous in that it allows building a servo loop which constantly monitors current and disables the AC receptacle in the event of excessive current. A Triac 14 or Relay can be used to interrupt current from entering AC receptacle 5. The Triac is preferably over-rated by a factor of five to help provide long life and avoid heat issues.

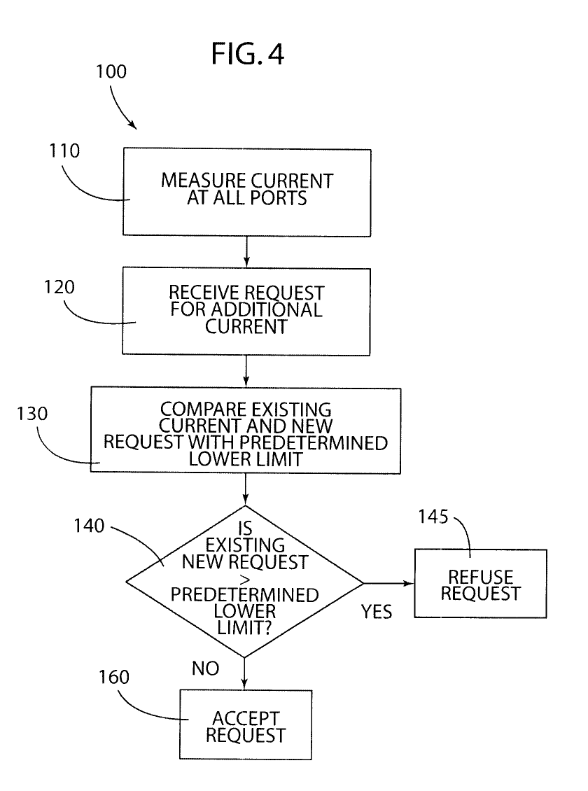

In accordance with a highly advantageous feature, pre-programmed routines on the controller advantageously allow for more complicated comparisons between intelligent power port devices, allowing for current sharing, optimization of power flow and protection of circuit breakers. For example, as shown in FIG. 4 a pre-programmed routine 100 comprises the steps of 110—each controller measures the current at its corresponding outlet to determine an existing current. 120—Each controller can receive a request for additional current (such as when a new user plugs in a new electrical device to another intelligent power port on the same main power line with other power ports), 130—compare the existing current with the request for additional current, and 140—if the request for additional current is less than a limit 160—grant the request at the outlet. If the new request exceeds the limit—145 refuse the Request. The limit can be set by continuously comparing a total amount of current from all of the outlets on the intelligent power port network and subtracting that current from a predetermined maximum current. The limit may also be a function of a maximum current limit at each outlet, set in the program at the controller to accommodate anticipated circuit breakers or other predetermined maximum current limit available at a given outlet.

The Triac 14 has a gate that is controlled by an optocoupler connected to the CPU 26. The CPU 26 can set the Optocoupler 14 to an ON or OFF state at any time. For example, a command may be sent to turn on GFI Receptacle/outlet 15, allowing power access at the outlet. An AC to DC Optocoupler 17 is used to monitor the output of Triac or Relay 14. The output of this Optocoupler 17 is monitored by CPU 26. The purpose of the input from 17 is to verify that Triac or Relay 14 is functioning. If there is a malfunction of the output of the Triac/Relay 14, for example, 14 is stuck in an ON state, then the CPU 26 may run a routine which sends a message to a master controller to respond and display a message at a display, as well as optionally disable the intelligent power port until it can be repaired.

The ground fault receptacle 15 is connected to the output of the Triac or Relay 14. The GFI 15 is used to protect people from current leakage or otherwise faulty equipment, as well as electric shock from misuse of the outlet. An AC to DC Optocoupler 18 is used to monitor the output of the GFI outlet 15. A “HOT” load terminal of the GFI 15 feeds the Optocoupler 18 the status of whether the GFI outlet 15 is tripped, allowing for monitoring by the CPU 26. A preprogrammed routine can monitor the trip status of the GFI 15 based on this status information. If GFI 15 has been tripped due to faulty equipment or shock the status can be logged and a beeping sound can be enabled. In such a situation a master controller can display a message to have a reset button pushed to reset the unit, for example. Resetting of the GFI 15 may be done manually using the intelligent power port.

The Current Fault Monitor Driver 31 circuit is designed to control and monitor optional USB ports 28 and Fire-Wire Ports 29. The circuit 31 first senses current being used by ports 28 or 29. If current exceeds a preprogrammed value determined by CPU 26 then the CPU 26 will disable that port until its current value is lowered or removed. This helps to ensure that the ports 28, 29 do not exceed current levels specified by ANSI standards. Current level at each port is also used to know if there is a load present at the port. If a load is disconnected while a time session for use of the intelligent power port is in process, then the CPU 26 is notified that a user may be done with his session early. Concession rules may be programmed into the CPU in one of several ways. For example, the CPU can issue a command to end the session early and shut off power to the ports. Alternatively, the CPU can allow power to be accessed from the ports for a predetermined period of time, either based on a user's payment (a pay for use model where the intelligent power port device includes a financial collection device which receives financial remuneration from a user, such as a credit card payment terminal) or upon another predetermined parameter. The circuit 31 also will preferably shut off ports on both USB ports 28 and Fire-Wire Ports 29 if they are shorted to ground. Fault status pertaining to a short is also communicated to the CPU 26. Such fault status can serve as a trigger for pre-programmed routines to be initiated. When the short to ground is removed the plugs 28 and 29 will return to operational status. The driver portion of the circuit can control the ON/OFF status of both plugs 28 and 29. Serial data can also be sent from the Serial Control 40 to the USB Ports 28.

The Ethernet Port 30 is connected to Driver 36. Driver circuit 36 may help control and limit power to the Ethernet port for Power over Ethernet “POE” devices. The Driver Circuit 31 can also allow data to flow from or to a network device that could be connected to it, such as Internet data. Driver circuit 31 is connected to CPU 26 and can be enabled or disabled by preprogrammed routines.

Inputs 19 are logic buffers that signals from other devices come to so that the CPU 26 can monitor them. Outputs 21 are logic buffers that all outputs from other devices come to so that the CPU 26 can control them. A Miniature Audio Transducer 20 can be connected to CPU 26 and acts as one type of output 21 from the CPU. The transducer 20 is an audio device which can be programmed to sound audible tones from 100 HZ to 10 kHZ and have control of volume using Pulse Width Modulation “PWM” techniques. These tones can be used for warning of a problem, or that the time on a paid session that was started and is about to run out, for example.

Another output is display 90. Display 90 can take on several forms, including, for example, an alphanumeric display, bar graph display, LEDs, graphic logo display, etc. The display 90 can have many functions. It can display a decimal number which will represent an address where the device may be programmed to activate the intelligent power port. For example, an intelligent power port may have a number associated with the device. It may be located among a group of power ports by entering the number on a keypad and only the intelligent power port that has the correct number will respond by displaying the correct number at its display. The display can also scroll a message simple message of status like OFF and ON. These messages can be preprogrammed routines controlled by CPU 26.

The display may also show, for example, the time left in a paid for session. When a power session is started a series of all LEDs will light up. As time counts down the CPU 26 may turn off one of LEDs from a left to right direction, for example. Each LED may preferably have a predetermined amount of time constant that may be attached to it in the pre-programmed routine. This constant can vary depending how long of a time session has been requested. For example in a pay for use model of the intelligent power port device the controller limits the time power is supplied by the outlet to a user's electric device. The intelligent power port device may receive a command to start a session for a thirty minute time period. The CPU 26 can calculate and divide ten LEDs into thirty minutes or three minutes for each LED. Another function of the display can be a stand alone mode when the outlets are not activated. In this case the display can show the amount of current capable of being drawn by the AC GFI receptacle 15. The CPU 26 can also calculate the ratio of current being used with a maximum predetermined level of current and display the ratio at the display. The display may also comprise a series of multiple blue LEDs behind a logo or graphic. This may be used to place advertisements or to capture a person's eye to the intelligent power port. The LEDs may be connected to the CPU 26 so that they may be programmed to chase, flash or fade at any time.

EE-Ram 27 or electrical erasable read access memory is used to store all parameters and faults from the CPU 26. The CPU 26 is preferably a self contained math unit, ROM, RAM and can have a PIC processor or Zilog series MPU. The CPU 26 preferably is programmable and has routines preprogrammed to operate in stand alone mode or slave mode to control parameters and functions to communicate with other controllers at other intelligent power ports grouped together on the same power line, or to a master controller. Software or firmware can be changed by in circuit programming port 46. This port 46 can be accessed by internally on a controller board. This feature saves the processor from being removed from the circuit board to be programmed. The processor can also be upgraded thru the I2C BUS 80 or one of the Expansion wireless technologies 42 adapters. The plugs or ports are preferably connected to an intermediate plug controller via an I2C bus 80. This controller talks to the plugs using the bus for at least the following reasons: sending operating parameters to the plugs; instructing the plugs to turn on or off; and/or gathering power session metrics stored on the plugs. A boot loader routine loaded in the CPU 26 upper memory will make field firmware upgrades the most cost effective and avoids the need to disassemble the device. 5 V DC power bus supplies power for all logic circuits.

The master controller 112 can communicate with a nearby controller unit, as well as with a financial renumeration device such as a credit card payment terminal, money acceptor, etc., as well as with a keypad for selecting an intelligent power port, a PDA, etc. This master controller may perform operations such as sending operating parameters, turning the intelligent power port on and off, gathering metrics about the port, etc. Each individual intelligent power port on the network may store power session information for subsequent data harvesting operations. For example, metrics such as charging duration, average power consumed by plugged in devices, timestamp, etc. may be stored in the plug microcontroller's memory until the master controller can retrieve the information. The master controller 112 can use a wireless transceiver to communicate other controllers which may optionally be a wired transceiver, or it may be connected to other controllers using a broadband over power line, as discussed below.

Wireless Expansion Technologies 44 socket makes it very easy to customize the intelligent power port device to interface with other wireless technologies. The use of a serial controller 40 interface attached to CPU 26 makes this possible with minimal amount CPU processing power and allows for keeping standard communication protocols. All that is needed is to pick and place the wireless expansion board that best fits the customer's needs.

A broadband over power line communications interface 45 can be attached to communicate between controllers on the main power line. That is, data from each controller is transmitted through AC power lines, rather than over a separate dedicated data transmission line. Power line communication can be used to leverage this existing wires-infrastructure to carry information as well as power.

From the foregoing disclosure and detailed description of certain preferred embodiments, it will be apparent that various modifications, additions and other alternative embodiments are possible without departing from the true scope and spirit of the invention. The embodiments discussed were chosen and described to provide the best illustration of the principles of the invention and its practical application to thereby enable one of ordinary skill in the art to use the invention in various embodiments and with various modifications as are suited to the particular use contemplated. All such modifications and variations are within the scope of the invention as determined by the appended claims when interpreted in accordance with the breadth to which they are fairly, legally, and equitably entitled.

What is claimed is:

1. An intelligent power port device comprising, in combination:
an outlet providing power; and
a controller located adjacent the outlet which monitors current and voltage at the outlet, and which is programmable to control power supplied by the outlet.

2. The intelligent power port device of claim 1 wherein the controller is in electrical communication with controllers of other intelligent power port devices, forming an intelligent power port network.

3. The intelligent power port device of claim 2 wherein the controllers are in electrical communication with one another using broadband communication over a power line.

4. The intelligent power port device of claim 1 wherein the controller limits the time power is supplied by the outlet.

5. The intelligent power port device of claim 4 further comprising a financial collection device which receives financial remuneration from a user of the device in exchange for a limited period of access to at least one of the plurality of ports.

6. The intelligent power port device of claim 1 further comprising a data transmission port.

7. The intelligent power port device of claim 6 wherein the data transmission port is one of a USB port, a Fire-Wire port and an Ethernet port.

8. The intelligent power port device of claim 2 wherein at least one controller is wirelessly connected to at least one other controller.

9. The intelligent power port device of claim 2 wherein each controller measures the current at its corresponding outlet to determine an existing current, can receive a request for additional current, and compare the existing current with the request for additional current, and if the request for additional current is less than a limit grant the request at the outlet.

10. The intelligent power port device of claim 9 wherein the limit is set by continuously comparing a total amount of current from all of the outlets on the intelligent power port network and subtracting that current from a predetermined maximum current.

11. The intelligent power port device of claim 9 wherein the limit is a programmed maximum current limit at each outlet.

12. The intelligent power port device of claim 1 wherein the power supplied at the outlet is one of AC and DC.
